(19) United States
(12) Patent Application Publication
(10) Pub. No.: US 2024/0189908 A1
(43) Pub. Date: Jun. 13, 2024

(54) METHOD FOR MANUFACTURING A METAL ALLOY PART FOR A TURBINE ENGINE

(71) Applicant: SAFRAN AIRCRAFT ENGINES, Paris (FR)

(72) Inventors: Arnaud TUREL, MOISSY-CRAMAYEL (FR); Mickaël VOIRON, MOISSY-CRAMAYEL (FR)

(73) Assignee: SAFRAN AIRCRAFT ENGINES, Paris (FR)

(21) Appl. No.: 18/551,822

(22) PCT Filed: Mar. 21, 2022
(86) PCT No.: PCT/FR2022/050509

§ 371 Date: Sep. 21, 2023

(30) Foreign Application Priority Data
Mar. 26, 2021 (FR) 2103084

(51) Int. Cl. B22F 10/66; B22F 5/00; B22F 10/28; B22F 10/68; B23P 15/02; B33Y 10/00; B33Y 40/20; B33Y 80/00

(52) U.S. Cl. CPC B22F 10/66; B22F 5/009; B22F 10/28; B22F 10/68; B23P 15/02; B33Y 10/00; B33Y 40/20; B33Y 80/00; B22F 2202/01; B22F 2998/10; B22F 2999/00

(57) ABSTRACT

A method for manufacturing a metal alloy part for an aircraft turbine engine, the method including the steps of: (a) producing a blank of the part by additive manufacturing by laser fusion on a powder bed, and (b) abrasively machining the blank to obtain the part, the machining being carried out by vibratory finishing by immersing the blank in an abrasive composition contained in a tank subjected to a vibratory movement, the abrasive composition having an abrasive element formed by alumina particles, a carrying element formed by copper particles, and a liquid.

### TECHNICAL FIELD OF THE INVENTION

This invention relates to a method for manufacturing a metal alloy part for an aircraft turbine engine, including a step of additive manufacturing by laser fusion on a powder bed.

### TECHNICAL BACKGROUND

The technical background comprises in particular the documents WO-A1-2015/055601, FR-A1-3 058 457, WO-A1-2012/0013624, US-A1-2014/235146 and US-A1-2016/346896.

Because they are highly competitive in terms of production cost, throughput and processing efficiency, the powder metallurgy forming methods, and more specifically additive manufacturing, have seen renewed interest in recent years, particularly in the aerospace industry for the manufacture of parts of an aircraft turbine engine.

Although these manufacturing methods allows to produce parts with complex geometries close to finished dimensions, the surface finish at the end of the method remains unacceptable. The roughness levels obtained after additive manufacturing are often very coarse and the roughness Ra may vary from 10 to 50 μm depending on the manufacturing strategies, the type of powder used, the manufacturing conditions implemented and the orientation of the parts during construction. These high levels of roughness have a negative impact on the mechanical properties of the parts and on the performance of the turbine engine, particularly in areas where the airflow passes through, as is the case with parts comprising at least one aerodynamic blade (vane, dispenser, rectifier, etc.).

The aerospace parts produced by additive manufacturing must therefore be systematically finished, mainly to achieve acceptable levels of roughness.

The additive manufacturing is a manufacturing method that emerged in the 1990s. This is a manufacturing method that allows a physical object to be produced layer by layer from a digital file by adding material. These manufacturing methods allow a part to be produced directly, close to its finished dimensions.

Parts of aircraft turbine engine, such as the rectifiers, can be manufactured using laser fusion technology on a powder bed, otherwise referred to as Selective Laser Melting (SLM) or Laser Beam Melting (LBM).

This technology consists of fusing successive beds of powder 10 with a laser 12 until the part 14 is obtained (FIG. 1) and is well known to the person skilled in the art in the additive manufacture of aeronautical parts.

A thickness of powder 10 (20-60 μm) is spread out and the laser 12 fuses (following a defined scanning strategy) the powder following the geometry of the part 14 to be produced. The unfused powder is removed and a new bed of powder 10 is spread out so that a new laser scanning cycle can be performed.

The surface state of a part 14 produced by additive manufacturing can be improved by vibratory finishing. The vibratory finishing covers all the industrial abrasive machining methods used to improve roughness or the microroughness, deburring, scribing, burnishing or descaling by moving an abrasive composition around a part in a tank.

From a scientific point of view, three phenomena can be involved in the vibratory finishing: abrasion (particularly for roughness reduction), shearing (particularly for scribing and deburring), and percussion (particularly for burnishing).

There are several types of vibratory finishing installations, including:
a) the tumbling: this consists of a tank which is rotated around a horizontal axis and which contains the abrasive composition and the part which is stationary or free in the tank;
b) the linear and circular vibrators: these consist of a vibrating tank that sets the abrasive composition in motion and contains the part, which may also be stationary or mobile;
c) the centrifugal force machine: this is a machine in which the abrasive composition is set in motion by kinetic energy in a tank, this tank comprising a plate rotating at high speed at the bottom; the part is free in the tank;
d) the drag finishing machine: this is a machine in which the part is set in epicyclic motion in a tank containing the abrasive composition; and
e) the Surf finishing: this consists of a tank that rotates around a vertical axis and contains the abrasive composition and the part, which may be stationary or free in the tank.

When it comes to finishing parts produced by additive manufacturing, these technologies are not enough, particularly as they do not completely allow to reduce the very high levels of roughness found on raw parts produced by additive manufacturing, and they generally do not allow work to be carried out in restricted areas that are difficult to access. These methods must therefore be preceded by other methods such as abrasive paste polishing, sandblasting or chemical methods.

Many of these technologies therefore need to be combined to finish parts resulting from additive manufacturing with complex geometries.

There is therefore a need for a vibratory finishing solution that can simplify the manufacturing method for an aeronautical part that includes an additive manufacturing step using laser fusion on a powder bed.

### SUMMARY OF THE INVENTION

The invention relates to a method for manufacturing a metal alloy part for an aircraft turbine engine, the method comprising the steps of:
a) producing a blank of the part by additive manufacturing using laser fusion on a powder bed, and
b) abrasively machining the blank to obtain the part, this machining being carried out by vibratory finishing by immersing the blank in an abrasive composition contained in a tank subjected to a vibratory movement,
the abrasive composition comprising an abrasive element formed by alumina particles, a carrying element formed by copper particles, and a liquid, and
step b) comprising a first cycle of vibratory finishing the blank in the abrasive composition, and at least one further cycle of vibratory finishing the blank at the start of which some or all of the abrasive composition is evacuated and replaced by a new abrasive composition of the same formulation, the orientation of the part in the tank being changed between two successive cycles of vibratory finishing.

The invention thus proposes a specific abrasive composition for the vibratory finishing of a metal blank obtained by additive manufacturing. Among the technologies described above, the invention uses vibratory or vibratory finishing.

In this application, “abrasive element” means an element which has an abrasive function, i.e. a function of surface treatment by abrasion of a part in order to modify its roughness and in particular to reduce its roughness in the context of the invention. An abrasive element generally has a hardness greater than that of the part to be treated, and therefore greater than that of a metal alloy in the context of the invention. According to the invention, the abrasive element is formed by particles of alumina (Al₂O₃). Alumina is a ceramic material with high hardness and chemical stability.

In the present application, a carrying element is taken to mean an element whose function is to promote the creation of a flow of the abrasive composition in the tank. The carrying element is independent and separate from the abrasive element. When the tank vibrates, the carrying element is set in motion in the tank, driven the abrasive element with it. This creates a flow of the abrasive composition inside the tank, allowing the abrasive element to circulate on and around the part and perform its abrasive machining function. A carrying element generally has a higher density than the abrasive element. According to the invention, the carrying element is formed by copper particles. Copper is so dense and hard that it does not bounce off the part as it moves through the tank.

The liquid in the abrasive composition allows to fluidise the flow of this composition in the tank and facilitates the cleaning of the part and the evacuation of the material removed from the part by abrasion. It also allows to lubricate the part and prevents the temperature from rising due to friction.

The method according to the invention may comprise one or more of the following characteristics, taken alone or in combination with each other:
the abrasive element is harder than the part to be treated;
the alumina particles have an average diameter or a size of between 5 and 100 μm, and preferably between 10 and 70 μm; they may be of any shape;
the carrying element has a higher density than that of the abrasive element;
the copper particles have an average diameter or a size of between 0.5 and 5 mm, and preferably between 1 and 4 mm; they may be of any shape; for example, they may be in the form of parallelepipedal plates and have a thickness of the order of 1 mm, for example;
the part is made of a titanium, nickel or iron-based alloy;
the abrasive composition comprises between 0.05 and 0.4%, and preferably between 0.1 and 0.2%, by weight of abrasive element, and between 95 and 99%, and preferably 96 and 98%, by weight of carrying element, the remainder of the abrasive composition being formed by the liquid;
the ratio R1=Q1/Q2 is between 200 and 2000, and preferably between 500 and 1000, with Q1 the weight of the carrying element in the abrasive composition and Q2 the weight of the abrasive element in the abrasive composition;
the abrasive composition comprises between 0.6 and 4.95%, and preferably between 1.8 and 3.9%, by weight of liquid;
the ratio R2=Q1/Q3 is between 10 and 500, and preferably between 30 and 300, with Q1 the weight of the carrying element in the abrasive composition and Q3 the weight of the liquid in the abrasive composition;
the ratio R3=Q3/Q2 is between 5 and 50, and preferably between 10 and 30, with Q3 the weight of the liquid in the abrasive composition and Q2 the weight of the abrasive element in the abrasive composition;
the blank is fully immersed in the abrasive composition in step b);
the blank is located at a height in the tank or extends to a maximum height in the tank which is at most 30%, and preferably at most 15%, of the maximum height of the abrasive composition in the tank;
the liquid of the abrasive composition is an aqueous solution containing at least one surfactant and possibly other additives;
step b) comprises a first cycle of vibratory finishing the blank in the abrasive composition, and at least one further cycle of vibratory finishing the blank, at the beginning of which the abrasive composition is at least partly evacuated and replaced by a new abrasive composition of the same formulation, it being possible to change the orientation of the part in the tank between two successive cycles;
the vibratory movement is carried out at a frequency of between 30 and 60 Hz, and preferably between 40 and 50 Hz;
the vibratory movement is carried out along the three axes of an orthonormal reference frame;
the part comprises at least one aerodynamic blade and, for example, several adjacent aerodynamic blades forming a monobloc assembly referred to as a rectifier;
the part is held in the tank by a tooling comprising jaws for clamping the part and a flat ferromagnetic base, this base being placed at the bottom and in the centre of the tank and held fixedly by an electromagnetic field;
the method comprises, between steps a) and b), a step i) of thermal treating the blank, and/or a step ii) of machining the blank to remove manufacturing supports;
the method comprises, after step b), a step x) of decontaminating the part by immersing it in a decontamination bath, or successive steps y) and z) of degreasing and penetrant testing the part;
the decontamination bath comprises an aqueous solution comprising at least one acid such as nitric acid.

### BRIEF DESCRIPTION OF THE FIGURES

Further characteristics and advantages will be apparent from the following description of a non-limiting embodiment of the invention with reference to the appended drawings in which:

FIG. 1 is a very schematic view of an additive manufacturing installation using laser fusion on a powder bed, and illustrates a first step of the method according to the invention;

FIG. 2 is a flow chart representing an embodiment of a method according to the invention for manufacturing a metal alloy part for an aircraft turbine engine;

FIG. 3 is a very schematic view of a vibrating tank containing an abrasive composition in which the part to be treated is immersed, and illustrates another step in the method according to the invention;

FIG. 4 is a larger scale view of the part and the support of this part in the tank, and illustrates the direction of an abrasive flow at the level of the part to be treated in the tank;

FIG. 5 is a schematic perspective view of a tooling for attaching the part and holding this part in the tank, the part in this case being an aircraft turbine engine rectifier and being held in a first position; and

FIG. 6 is another schematic perspective view of the tooling and of the part of FIG. 5, a portion of the tooling having been rotated about a horizontal axis to hold the part in a second position.

### DETAILED DESCRIPTION OF THE INVENTION

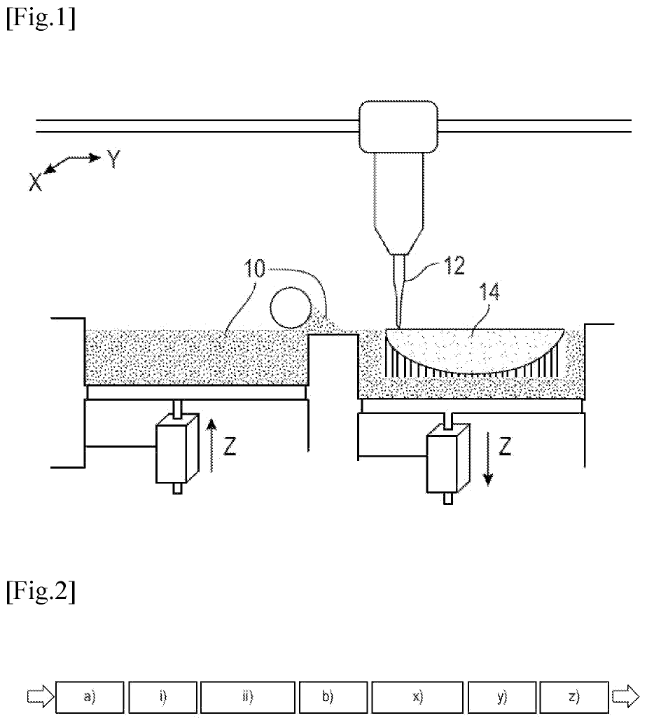

FIG. 1 has been briefly described above and illustrates step a) of a method according to the invention for the additive manufacture of a metal alloy part for an aircraft turbine engine.

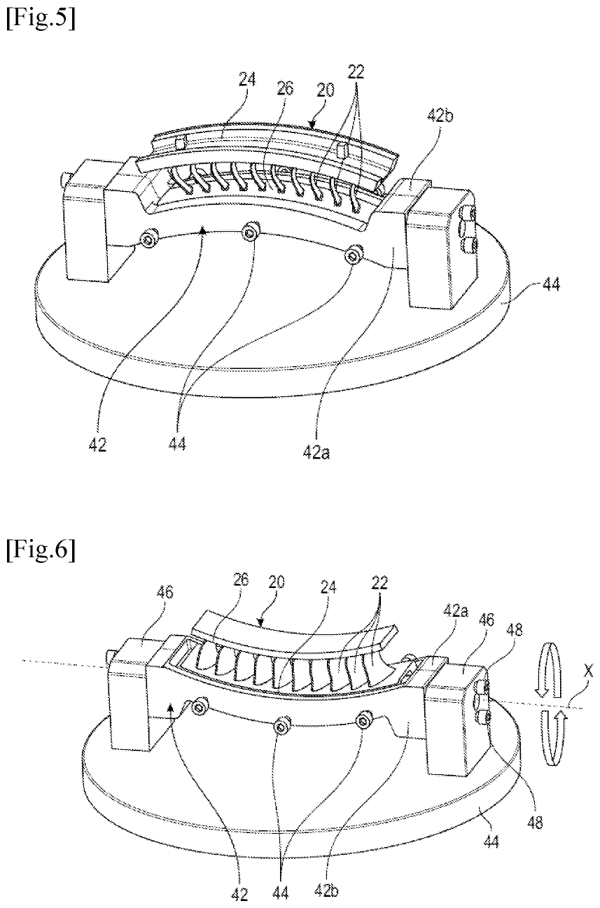

The part to be manufactured comprises, for example, at least one aerodynamic blade and, for example, several adjacent aerodynamic blades. This is the case, for example, of a rectifier 20, as illustrated in FIGS. 5 and 6, which comprises several adjacent blades 22, the ends of which are connected to shells 24, 26.

A turbine engine rectifier 20 has an annular shape around an axis of revolution and the part shown in FIGS. 5 and 6 is in fact a rectifier sector, i.e. an angular portion of the rectifier. Sectoring a rectifier allows to make it easier to manufacture and assemble.

The rectifier sector shown in FIGS. 5 and 6 forms a monobloc assembly which is produced by the method according to the invention.

FIG. 2 shows a non-limiting embodiment of the method according to the invention, with mandatory steps and optional steps.

The two mandatory steps are:
a) producing a blank 30 for the part by additive manufacturing using laser fusion on a powder bed, using the installation 16 shown in FIG. 1, and
b) abrasively machining the blank 30 to obtain the part (and for example the rectifier 20 in the above-mentioned particular case), this machining being carried out by vibratory finishing by immersing the blank 30 in an abrasive composition 32 contained in a tank 34 subjected to a vibratory movement.

Additive manufacturing step a) will not be detailed in the following as it is considered to be part of the general knowledge of the person skilled in the art in the field in question.

Preferably, the blank 30 is made from a powder of a nickel-based alloy (e.g. Inconel 718), titanium or iron. Unlike the drawings which show a blank 30 in the form of a simple test piece, the blank can have a complex shape, as illustrated in FIGS. 5 and 6. The resulting blank 30 has a high degree of surface roughness, which is reduced by the vibratory finishing step b).

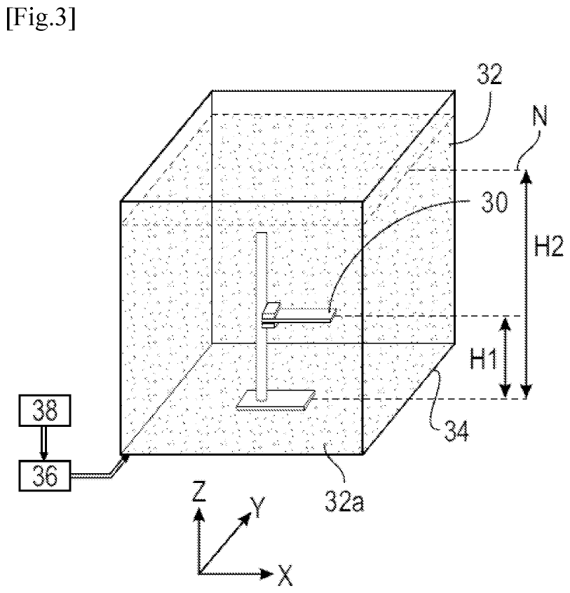

This vibratory finishing is carried out by means of a vibrating tank 34, illustrated schematically in FIG. 3. This vibrating tank 34 is of any general shape and contains the abrasive composition 32 in which the blank 30 to be treated is immersed. For example, the tank 34 has a cubic shape with 40 cm sides.

The tank 34 forms part of a vibratory finishing installation which is not shown in the drawings for the sake of clarity. The installation comprises, for example, motorised means 36 configured to impose a vibratory movement on the tank 32, as well as control means 38 for controlling these motorised means. This installation is, for example, similar to that described in the document US-A1-2014/235146.

According to the invention, the abrasive composition 32 contained in the tank 34 comprises an abrasive element formed by alumina particles, a carrying element formed by copper particles, and a liquid.

The abrasive composition 32 preferably comprises between 0.05 and 0.4% by weight of abrasive element, and between 95 and 99% by weight of carrying element, the remainder of the abrasive composition being formed by the liquid.

The liquid of the abrasive composition preferably comprises between 2 and 8% by weight, and more preferably between 4 and 5% by weight, of additives. Above a certain level of additives, there is a risk of hot corrosion of the part if residual traces of additives remain on the part in service (in flight).

The alumina particles have an average diameter or size of between 5 and 100 μm, and preferably between 10 and 70 μm. They can be of any shape.

The copper particles have an average diameter or a size of between 0.5 and 5 mm, and preferably between 1 and 4 mm. They can be of any shape and can, for example, take the form of parallelepipedal plates.

Q1, Q2 and Q3 are defined, respectively, as the weight of the carrying element in the abrasive composition 32, the weight of the abrasive element in the abrasive composition 32, and the weight of the liquid in the abrasive composition 32. The inventors have found that an increase in the amount of abrasive element in the composition leads to an improvement in the final surface state of the part, and that an increase in the amount of carrying element in the composition also leads to an improvement in the final surface state of the part.

Advantageously, the ratio:
R1=Q1/Q2 is between 200 and 2000, and preferably between 500 and 1000, and/or
R2=Q1/Q3 is between 10 and 500, and preferably between 30 and 300, and/or
R3=Q3/Q2 is between 5 and 50, and preferably between 10 and 30.
Q1 is preferably greater than 300 Kg, depending on the capacity of the tank.
Q2 is preferably between 300 and 600 g.
Q3 is preferably between 3 and 10 kg, and more preferably between 5 and 9 kg.

The abrasive element is, for example, that marketed by SPM under the name TRI.AL® 860 G.

The carrying element, for example, is 99.9% pure. It therefore consists mainly of copper.

The liquid in the abrasive composition 32 is preferably an aqueous solution containing at least one surfactant and possibly other additives. The liquid may be an aqueous mixture of products marketed by SPM under the names Lucibril® A320 R and FAM 521.

The vibratory movement is carried out along the axes x, y and z. This vibratory movement is carried out, for example, at a frequency of between 30 and 60 Hz, and preferably between 40 and 50 Hz.

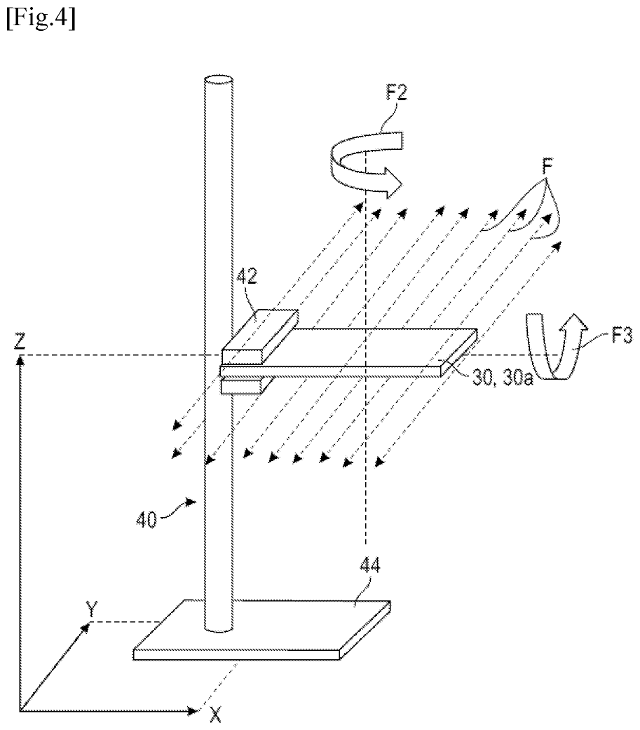

This vibratory movement generates a displacement of the carrying element and therefore of the copper particles in the tank 34. The displacement of the copper particles causes the alumina particles to move and therefore all the particles in the tank move. The vibrating composition therefore vibrates in the three directions x, y and z in the tank and moves mainly in one direction within the tank, here along the axis Y. This direction of movement is horizontal and parallel to a bottom 34a of the tank 34 to which the blank 30 is attached. The liquid helps to fluidise this movement and form an abrasive flow in the tank 34, which is represented schematically by the double arrows F in FIG. 4. This abrasive flow therefore depends on the vibratory movement of the tank 34.

The movements imposed on the tank 34 may be rectilinear, circular, etc. For example, the motorised means 36 can rotate clockwise or anti-clockwise, alternating between the two modes. This has the effect of changing the orientation of flow of the abrasive flow F while maintaining the same direction, and making the vibratory finishing as homogeneous as possible on the part.

The blank 30 is immersed in the composition 32 and is preferably completely immersed in the composition 32, as can be seen in FIG. 3. The blank 30 is located at a height H1 in the tank 34 or extends to a maximum height H1 in the tank.

The height H1 is preferably as low as possible so that the blank 30 is located as close as possible to the bottom of the tank, which allows to improve the abrasion phenomena during the vibratory finishing.

The height H1 may represent at most 30%, and preferably at most 15%, of the maximum height H2 of the abrasive composition 32 in the tank.

H1 is preferably between 5 and 10 cm.

In other words, it is preferable for the upper level N of the abrasive composition 32 in the tank 34 to be well above the blank 30 or its upper end.

The abrasive flow F allows to circulate the abrasive element in contact with the blank 30 for its vibratory finishing. It is understood that the blank 30 can be positioned in the tank 34 according to the direction of the flow F. For example, a flat surface 30a of the blank 30 will preferably be positioned parallel to the flow F to ensure that the alumina particles circulate on this surface and wear it down by friction (FIG. 4). The inventors have also found that abrasion is better when the surface 30a to be treated is oriented towards the top of the tank.

The orientation of the blank 30 in the tank 34 can be changed during step b) to ensure that all surfaces of the blank 30 are well treated by vibratory finishing.

Step b) may therefore comprise several vibratory finishing cycles. The duration of a vibratory finishing cycle depends in particular on the desired surface state of the part. The inventors have found that increasing this time leads to an improvement in the surface state. It should be noted that after a certain vibratory finishing time, the abrasion is no longer as effective as it was at the start of the cycle and the surface state no longer improves. It may then be necessary to restart a new vibratory finishing cycle.

The duration of a vibratory finishing cycle is a maximum of 8 hours.

Step b) comprises, for example, a first cycle of vibratory finishing of the blank 30 in the abrasive composition 32, during which the tank 34 is set in vibratory motion.

The movements of the tank 34 are stopped and the orientation of the blank 30 in the tank 34 can be changed, for example by rotating the blank 30 about a vertical axis z (arrow F2). An additional quantity of abrasive element is preferably added to the tank and some of the abrasive composition 32 can be removed or evacuated from the tank, allowing this composition to be recycled and ensuring that it still retains good abrasive properties. The entire abrasive composition can be evacuated and replaced with a new abrasive composition of the same formulation. Step b) then comprises a second cycle of vibratory finishing of the blank 30 in the abrasive composition 32, during which the tank 34 is set in vibratory motion.

The movements of the tank 34 are stopped and the orientation of the blank 30 in the tank 34 can be changed again, for example by rotating the blank about a horizontal axis x perpendicular to the axes y and z (arrow F3). A further quantity of abrasive element is preferably added back into the tank 34 and some of the abrasive composition 32 may be removed or evacuated from the tank. The entire abrasive composition can be evacuated and replaced with a new abrasive composition of the same formulation. Step b) then comprises a third cycle of vibratory finishing of the blank 30 in the abrasive composition 32, during which the tank is set in vibratory motion.

The number of vibratory finishing cycles is not limited and depends in particular on the shape of the part to be treated.

The blank 30 is held in the tank 34 by a tooling 40, shown very schematically in FIGS. 3 and 4. This tooling comprises means 42 for attaching the blank 30 and means 44 for attaching it to the bottom 32 of the tank 32. The tooling 40 is also configured to allow changes in the position and orientation of the blank in the tank 32, as described above.

FIGS. 5 and 6 show a more specific example of how tooling 40 can be used in vibratory finishing treatment of a rectifier 20 or rectifier sector.

The means 44 for attaching to the bottom 34a of the tank 34 comprise a flat ferromagnetic base which is configured to be placed on the bottom and in the centre of the tank 34 and held in place by an electromagnetic field, as explained in the document US-A1-2014/235146. The inventors have found that the optimum position for the part is in the centre of the tank to avoid the part being in a “dead area”, for example near an edge or a wedge of the tank, at the level where the abrasive flow may be weaker and the vibratory finishing less effective.

In this case, the base is generally disc-shaped so that it can be inserted and placed at the bottom of a generally cubic tank 34. The base is made of ferromagnetic material so that it is held firmly to the bottom of the tank solely by the magnetic field. The vibratory finishing installation then comprises magnets or similar configured to generate a magnetic field to immobilise the base at the bottom of the tank. This method for holding the tooling 40 means that there are no means of attaching it in the tank or at the bottom of the tank and that the circulation of the flow F of abrasive composition in the tank is not impeded.

Alternatively, the tooling 40 could be held at the bottom of the tank by mechanical means.

The means 42 for attaching the rectifier 20 comprise clamping jaws. These clamping jaws can be formed by two parts 42a, 42b clamped together by appropriate means such as screws 44 for example.

In the example shown, the rectifier 20 is held in place at the level of its shells 24, 26. The parts 42a, 42b comprise a first side shaped like a convex arc to receive and clamp the internal shell 26 between them (FIG. 5). The parts 42a, 42b comprise a second opposite side shaped like a concave arc to receive and clamp the external shell 24 between them (FIG. 5).

The tooling also comprises means 46 for connecting the jaws to the base. These connection means 46 comprise two supports which are attached to an upper surface of the base, opposite the bottom of the tank, and between which the attachment means 42 extend.

The attachment means 42 are movable in rotation relative to the connection means 46 about an axis, which is the axis x in the case of FIG. 4. The attachment means 42 can adopt a first position shown in FIG. 5, in which their first convex side is oriented upwards and receives the internal shell 26 of the rectifier 20. The attachment means 42 can adopt a second position shown in FIG. 6, in which their second concave side is oriented upwards and receives the external shell 24 of the rectifier 20. Moving the attachment means 42 between these two positions therefore allows the rectifier 42 to be presented in two positions about the axis x, located at 180° to each other. The attachment means 42 can be immobilised in a particular position relative to the connection means 46 by screws 48 or similar.

The rectifier can be moved about the axis z by stopping the magnetic field, rotating the base in the tank a quarter turn about the axis z, and reactivating the magnetic field.

The tooling 40 is preferably made from a material suitable for resisting abrasion and corrosion during vibratory finishing. For example, it is made of stainless steel, nitrided or covered with a protective polymer coating.

As schematically represented in the flow chart in FIG. 2, the method according to the invention may comprise, between steps a) and b), a step i) of thermal treatment of the blank, and/or a step ii) of machining the blank to remove supports which are created during additive manufacturing in step a). Machining in step ii) can be carried out by EDM (Electro Discharge Machining).

The method according to the invention may comprise, after step b), a step x) of decontaminating the part by immersing this part in a decontamination bath, or successive steps y) and z) of degreasing and penetrant testing the part.

Decontamination of the part in step x) is particularly advantageous to ensure that the part is not contaminated by the abrasive composition and in particular by any copper particles that may remain clinged to the part. These copper particles are likely to diffuse or release copper into the part during engine operation. These particles are also likely to mask potential cracks in the part that cannot be detected at the end of the manufacturing range during the control by penetrant testing.

The decontamination bath preferably comprises an aqueous solution comprising at least one acid such as nitric acid (HNO₃). The purpose of the acid is to dissolve the copper in solution, thereby eliminating the copper particles clinging to the part. The aqueous solution comprises, for example, 510 ml/L of HNO₃ and the part can be immersed in the bath for a period of, for example, 15 minutes.

1. A method for manufacturing a metal alloy part for an aircraft turbine engine, the method comprising the steps of:
(a) producing a blank of the metal alloy part by additive manufacturing using laser fusion on a powder bed; and
(b) abrasively machining the blank to obtain the metal alloy part, the machining being carried out by vibratory finishing by immersing the blank in an abrasive composition contained in a tank subjected to a vibratory movement, the abrasive composition comprising an abrasive element formed by alumina particles, a carrying element formed by copper particles, and a liquid, wherein step (b) further comprises:
a first cycle of vibratory finishing the blank in the abrasive composition; and
at least one further cycle of vibratory finishing the blank at the start of which some or all of the abrasive composition is evacuated and replaced by a new abrasive composition of the same formulation,
wherein the orientation of the part in the tank is changed between two successive cycles of vibratory finishing.

2. The method according to claim 1, wherein the metal alloy part is made of a titanium, nickel, or iron-based alloy.

3. The method according to claim 1, wherein the abrasive composition comprises between 0.05% and 0.4% by weight of abrasive element, and between 95% and 99% by weight of carrying element, the remainder of the abrasive composition being formed by the liquid.

4. The method according to claim 1, wherein the liquid of the abrasive composition is an aqueous solution containing at least one surfactant.

5. The method according to claim 1, wherein the vibratory movement is carried out at a frequency of between 30 and 60 Hz, or between 40 and 50 Hz.

6. The method according to claim 1, wherein the metal alloy part comprises at least one aerodynamic blade and, wherein several adjacent aerodynamic blades are configured to form a monobloc assembly of a rectifier.

7. The method according to claim 1, wherein the metal alloy part is held in the tank by a tooling comprising jaws for clamping the metal alloy part and flat ferromagnetic base, the base being placed at the bottom and in the center of the tank and held fixedly by an electromagnetic field.

8. The method according to claim 1, further comprising, after step (b) either a step (x) decontaminating the metal alloy part by immersing the metal alloy part in a decontamination bath, or step (y) degreasing the metal alloy part and step (z) penetrant testing the metal alloy part.

9. The method according to claim 8, wherein the decontamination bath includes an aqueous solution comprising at least one acid.

10. The method according to claim 1, wherein the abrasive element of the abrasive composition has a hardness greater than a hardness of the metal alloy part.

11. The method according to claim 1, wherein a density of the carrying element is higher density than a density of the abrasive element of the abrasive composition.

12. The method according to claim 1, wherein the abrasive composition comprises between 1.8% and 3.9% by weight of liquid.

13. The method according to claim 1, wherein the blank extends to a maximum height in the tank which is at most 30% or at most 15% of the maximum height of the abrasive composition in the tank.

14. The method according to claim 1, wherein the vibratory movement is carried out along the three axes of an orthonormal reference frame.

15. The method according to claim 1, further comprising, between steps (a) and (b), a step (i) of thermal treatment of the blank, and/or a step (ii) of machining the blank to remove manufacturing supports.
